(19) United States
(12) Patent Application Publication
(10) Pub. No.: US 2010/0047635 A1
(43) Pub. Date: Feb. 25, 2010

(54) Hydrating A Reactant Flow Of An Electrochemical Stack

(76) Inventor: Sean S. Lyons, Berne, NY (US)

Correspondence Address: TROP, PRUNER & HU, P.C., 1616 S. VOSS ROAD, SUITE 750, HOUSTON, TX, 77057-2631, US

(21) Appl. No.: 12/433,434

(22) Filed: Apr. 30, 2009

Related U.S. Application Data
(60) Provisional application No. 61/126,150, filed on May 1, 2008.

(51) Int. Cl. H01M 8/04

(52) U.S. Cl. 429/17; 429/19

(57) ABSTRACT

A technique includes communicating a reactant stream into a reactant plenum passageway of an electrochemical cell stack. Inside the reactant plenum passageway, water is injected into the reactant stream.

This application claims the benefit under 35 U.S.C. §119(e) to U.S. Provisional Patent Application Ser. No. 61/126,150, entitled, “HYDRATING A REACTANT FLOW OF AN ELECTROCHEMICAL STACK,” which was filed on May 1, 2008, and is hereby incorporated by reference in its entirety.

### BACKGROUND

The invention generally relates to hydrating a reactant flow of an electrochemical cell stack.

A fuel cell is an electrochemical device that converts chemical energy directly into electrical energy. There are many different types of fuel cells, such as solid oxide, molten carbonate, phosphoric acid, methanol and proton exchange member (PEM) fuel cells.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The PEM membranes typically must be kept moist during the operation of the fuel cell stack to optimize fuel cell performance. This typically means that a device such as a steam generator, humidifier, enthalpy wheel, etc. may be used to add moisture content to the reactant flows entering the fuel cell stack. During startup of the fuel cell system, the reactant flows typically are relatively dry, which increases the time needed to get the system to steady state operation.

Thus, there exists a continuing need for better ways to hydrate reactant flows of a fuel cell system, such as during the startup of the system.

### SUMMARY

In an embodiment of the invention, a technique includes communicating a reactant stream into a reactant plenum passageway of an electrochemical cell stack. Inside the reactant plenum passageway, water is injected into the reactant stream.

In another embodiment of the invention, a system includes an electrochemical cell stack that includes a reactant plenum passageway and an injector. The injector is located inside the reactant plenum passageway to inject water into a reactant stream.

Advantages and other features of the invention will become apparent from the following drawing, description and claims.

### BRIEF DESCRIPTION OF THE DRAWING

FIG. 1 is a schematic diagram of a hydration subsystem for an electrochemical cell stack according to an embodiment of the invention.

FIG. 2 is a cross-sectional view of a reactant water injection tube according to an embodiment of the invention.

FIG. 3 is a perspective view of a flow plate of the electrochemical cell stack of FIG. 1 according to an embodiment of the invention.

FIG. 4 is a flow diagram depicting a technique to hydrate a reactant flow according to an embodiment of the invention.

FIG. 5 is a schematic diagram of a fuel cell system according to an embodiment of the invention.

### DETAILED DESCRIPTION

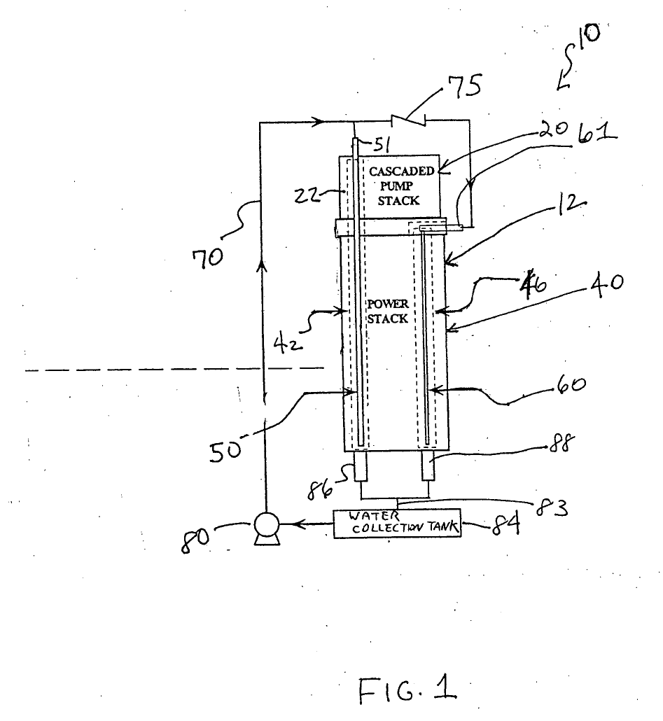

FIG. 1 depicts an exemplary embodiment of a hydration subsystem 10 for an electrochemical cell stack in accordance with embodiments of the invention. As described herein, the electrochemical cell stack may be a fuel cell stack, or power stack 40, that produces electrical power in response to fuel and oxidant flows through the stack 40. The power stack 40 is part of a larger stack assembly 12, which includes a cascaded pump stack 20 that is also an electrochemical cell stack that benefits from the hydration subsystem 10. The pump stack 20 contains a plurality of electrochemical cell pumps (hydrogen pumps, for example) that are cascaded together to purify an anode exhaust flow from the power stack 40 to produce a significantly pure fuel flow (a flow that contains approximately 99% hydrogen by volume, for example) that is routed back to the anode inlet of the power stack 40. More specifically, the cascaded pump stack 20 contains a cathode exhaust plenum 22 that furnishes the significantly pure hydrogen. The cathode exhaust plenum 22 is in communication with an anode inlet plenum passageway 42 of the power stack 40.

The membranes of the cascaded pump stack 20 and power stack 40 must be kept relatively moist for proper operation of the stacks 20 and 40. If not for the hydration subsystem 10, during startup of the system that incorporates the stack assembly 12, the reactant flow to the assembly 12 may be relatively dry, which may extend the startup time. However, the hydration subsystem 10 includes at least one water injector that is disposed inside the stack assembly 12 in at least one plenum passageway of the assembly 12 for purposes of injecting water into one or more reactant flows. Due to this arrangement, the reactant flows receive the necessary hydration to keep the proper water content at the cell membranes during startup.

As a more specific example, in accordance with some embodiments of the invention, the hydration subsystem 10 includes an anode water injection tube 50 that extends inside the anode inlet plenum passageway 42 of the power stack 40 and the cathode exhaust plenum passageway 22 of the cascading pump stack 20. The hydration subsystem 10 also includes a cathode water injection tube 60 that extends inside a cathode inlet plenum 46 of the power stack 40. At least during the startup of the power 40 and cascaded pump 20 stacks, water is injected into the anode 42 and cathode 46 inlet plenum passageways for purposes of hydrating the incoming anode and cathode flows, respectively, to the power stack 40.

In accordance with some embodiments of the invention, the hydration subsystem 10 includes a hydration pump 80 that receives and pressurizes water from a product water collection tank 84 of the subsystem 10. The pressurized water flows through a conduit 70 (in communication with an outlet of the hydration pump 80) to an inlet 51 of the anode injection tube 50 and an inlet 61 of the cathode water injection tube 60. As depicted in FIG. 1, a check valve 75 may separate the inlets 51 and 61 for purposes of separating the respective anode and cathode flows. The product water collection tank 84 receives water from water float traps 88 and 86 that are connected to receive water from the cathode inlet plenum passageway 60 and the anode inlet plenum passageway 42, respectively. The water traps 86 and 88 may share a common drain line 83 that leads to the product water collection tank 84, in accordance with some embodiments of the invention.

Thus, the water to be injected into the reactant flows is communicated from the water float traps 86 and 88; into the water collection tank 84; through the hydration pump 80; through the conduit 70, and to the injection tube inlets 51 and 61. The water is carried into the cathode and anode flow passageways of the cascaded pump stack 20 and power stack 40.

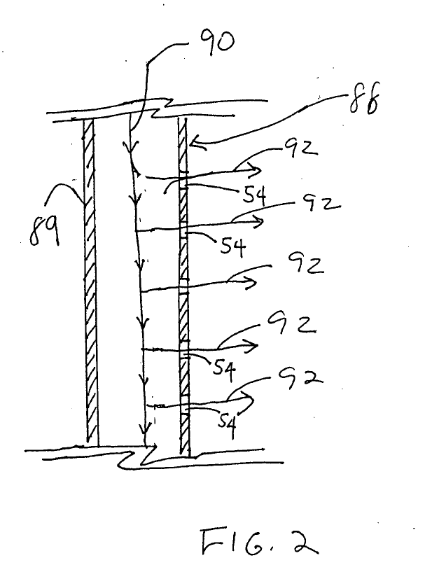

In accordance with some embodiments of the invention, the anode 50 or cathode 60 water injection tube may have a design similar to a water injector 88 that is depicted in FIG. 2. The water injector 88 may be formed from a tube 89 that may have a circular cross-section and may be perforated for purposes of forming radial jets of water. More specifically, in accordance with some embodiments of the invention, the water injector 88 may include openings 54 in the wall of the tube 89 for purposes of forming radial jets 92 from a stream of water 90 that flows through the central passageway of the tube 89. In accordance with some embodiments of the invention, the openings 54 have the same azimuthal orientation about the longitudinal axis of the tube 50 and are aligned with the reactant flow inlets of the flow plates of the power stack 40. In accordance with other embodiments of the invention, the openings 54 may vary over an azimuthal angle, or wedge, that is directed toward the flow plate inlets. Thus, many variations are possible and are within the scope of the appended claims.

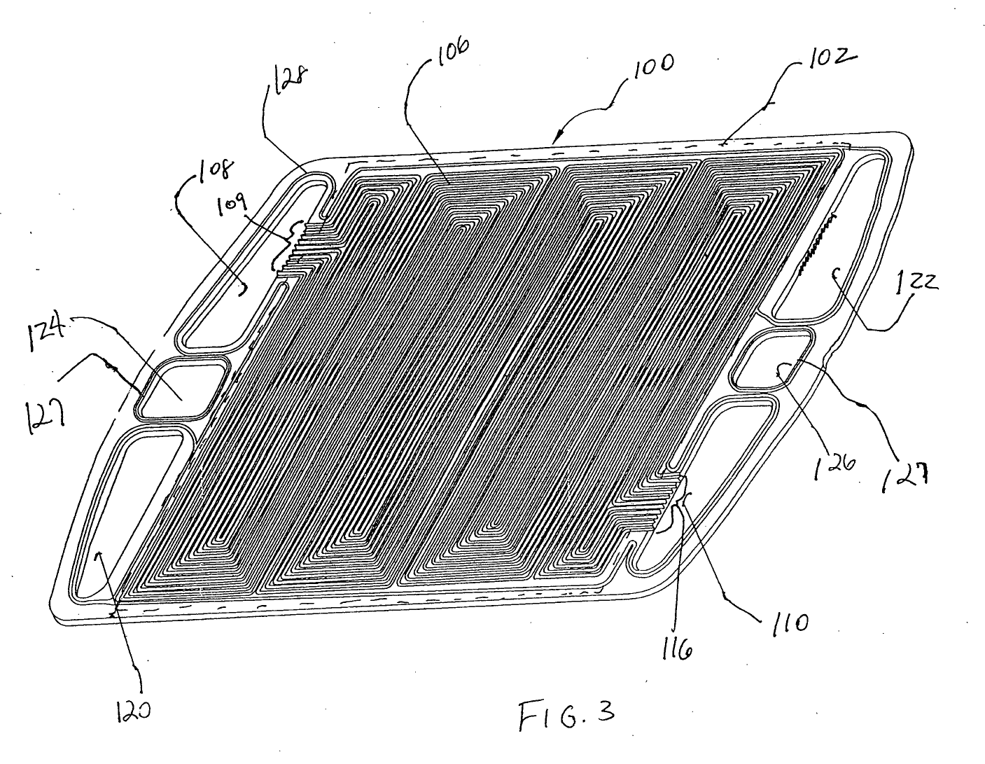

FIG. 3 depicts an exemplary embodiment of a flow plate 100 that may be used in the power stack 40, in accordance with some embodiments of the invention. The flow plate 100 includes an upper surface (depicted in FIG. 3) that has serpentine flow channels 106 for purposes of communicating a reactant, such as an anode fuel flow, to an adjacent membrane electrode assembly (MEA) of the fuel cell. The flow plate 100 includes various openings that form plenum passageways for the power stack 40.

More particularly, the flow plate 100 may include an opening 108 that in conjunction with similar openings of the other flow plates, the anode inlet plenum passageway 42 (see FIG. 1). As depicted in FIG. 3, the flow channels 106 extend to the opening 108 to form an inlet 109 that receives an incoming fuel flow from the anode inlet plenum passageway 42. Thus, incoming fuel flows from the anode inlet plenum passageway into the inlet 109, through the serpentine flow channels 106 and exits the flow channels 106 at an outlet 116. The outlet 116, in turn, is in communication with the anode outlet plenum passageway of the power stack 40. In this regard, the flow plate 100 includes an opening 110 that, in conjunction with similar openings in other flow plates form an anode outlet plenum passageway for the power stack 40.

The flow plate 100 includes other openings to form portions of the other plenum passageways of the power stack 40. For example, in accordance with some embodiments of the invention, the flow plate 100 includes an opening 120 that forms part of the cathode inlet plenum passageway 60 (see FIG. 1), an opening 122 that forms part of the cathode outlet passageway, an opening 124 that forms part of a coolant inlet plenum passageway, and an opening 126 that forms part of a coolant outlet passageway. The above-described reactant and coolant regions that are present on the upper side (depicted in FIG. 3) of the flow plate 100 may be isolated via seals 127 and 128. Similar seals may be used to isolate reactant and coolant flows on the bottom side of the flow plate 100.

The top surface of the flow plate 100 is associated with the anode flow, and the bottom surface of the flow plate 100 may be associated with, for example, a coolant flow in accordance with some embodiments of the invention. Thus, the power stack 40 may be formed from a repeating two flow plate design (of anode cooler flow plates, such as the flow plate 100, and cathode cooler flow plates), in which each fuel cell is formed from the flow plate 100 and an adjacent flow plate that is associated with the cathode flow. In this regard, in the adjacent flow plate may have the bottom surface with cathode flow channels for purposes of communicating oxidant to the MEA that is located between this other flow plate and the flow plate 100. Furthermore, the upper surface of the adjacent other flow plate may include coolant passageways that align with corresponding coolant passageways on the bottom surface of an adjacent flow plate, similar in design to the flow plate 100. It is noted that the above-described two flow plate cell design is an example only, as other fuel cell structures (a three flow plate design formed from an anode flow plate, and cathode flow plate and a bipolar flow plate) are possible and are within the scope of the appended claims.

Referring to FIG. 3 in conjunction with FIG. 1, in accordance with some embodiments of the invention, the anode water injection tube 50 is inserted through the anode inlet plenum passageway 42 such that the tube 50 is inserted through the opening 108. Referring also to FIG. 2, the anode water injection tube 50 is oriented such that the openings 54 direct the radial jets 92 toward the inlet 109 of the serpentine flow channels 106 of each anode cooler flow plate. Likewise, the cathode water injection tube 60 is inserted into the cathode inlet plenum passageway 46 and as such, is inserted through the opening 112. The openings of the cathode water injection tube 60 are oriented to direct radial jets toward the corresponding cathode flow channel inlets of the cathode cooler flow plates.

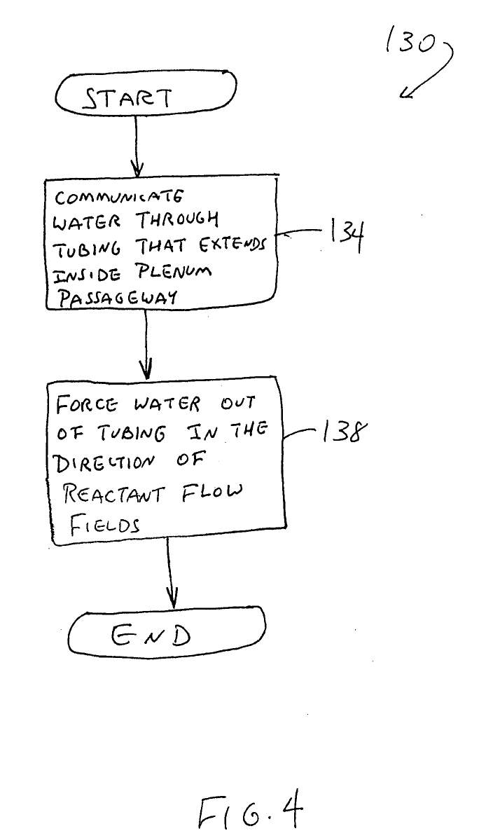

To summarize, FIG. 4 depicts a technique 130 that may generally be use in accordance with some embodiments of the invention. Pursuant to the technique 130, water is communicated (block 134) through a tubing that extends inside a plenum passageway of an electrochemical cell stack. Water is forced out (block 138) from the tubing in the direction of the reactant flow fields.

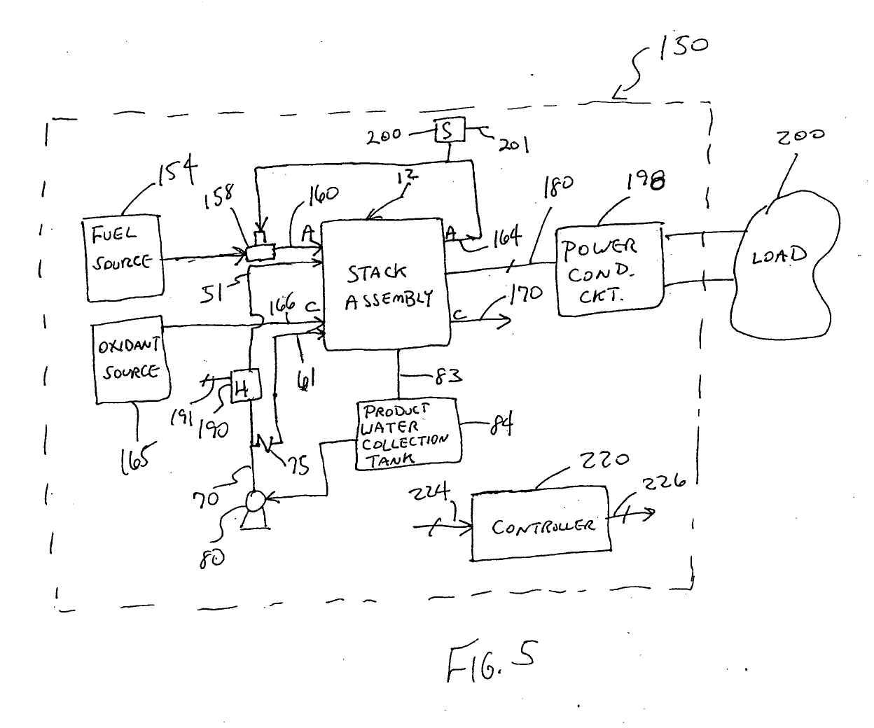

As a more specific example, FIG. 5 depicts an exemplary embodiment 150 of a fuel cell system in accordance with some embodiments of the invention. The fuel cell system 150 may, for example, produce electrical power for a load 200. The load 200 may be a residential or a commercial load, depending on the particular embodiment of the invention.

The fuel cell system 150 includes the stack assembly 12, which includes the power stack 40 (see FIG. 1) to produce electrical power for the load 200 and the cascaded pump stack 20 to extract fuel from the anode exhaust of the power stack 40. In accordance with some embodiments of the invention, the stack assembly 12 includes an anode inlet 160 that receives an incoming flow of fuel to promote the electrochemical reactions within the stack assembly 12. As shown, the fuel cell system 150 may include a venturi 158 that combines a feedback flow with a fresh fuel supply (from a fuel source 154) to the anode inlet 160. In this regard, the venturi 158 creates a pressure drop between the anode inlet 160 and an anode inlet 164 of the stack assembly 12 for purposes of creating a recirculation fuel flow, without the need for a recirculation blower, for example. The venturi 158 has a main path connected between the fuel source 154 and the anode inlet 160. The venturi inlet is connected to the anode exhaust outlet 164.

In accordance with some embodiments of the invention, the anode exhaust outlet 164 is the purified fuel flow that is produced by the cascaded pump stack 20 (see FIG. 1). Thus, this exhaust is a relatively pure fuel flow (a relatively pure such as approximately 99% pure hydrogen by volume, for example) from the stack assembly 12. It is noted that the stack assembly 12 may include another anode exhaust for purposes of routing the exhaust from the cascaded pump stack 40 from the stack assembly 12. This other exhaust may be routed to a flare or oxidizer or may be vented to ambient, depending on the particular embodiment of the invention.

The stack assembly 12 also includes a cathode inlet 166 for purposes of receiving an air reactant stream (provided by an oxidant source 165, such as an air blower, for example) for the stack assembly 12. This air reactant stream is routed into the cathode inlet plenum passageway 46 of the power stack 40. The stack assembly 12 also includes a cathode exhaust outlet 170. The cathode exhaust may be rerouted back to the cathode inlet 166 in accordance with some embodiments of the invention. In other embodiments of the invention, the cathode exhaust may be routed to a flare or oxidizer or may be vented to ambient. Therefore, many variations are possible and are within the scope of the appended claims.

Thus, the stack assembly 12 receives an incoming fuel flow at its anode inlet 160. This fuel flow is directed into the anode inlet plenum passageway 42, where the fuel flow enters the anode flow channels of the cascaded pump stack 20 as well as the anode flow channels of the power stack 40. Inside the cascaded pump stack 20, the anode flow is further purified to produce fuel that is fed back to the anode inlet 160. The anode flow inside the power stack 42 may be combined with the output from the cascaded pump stack 20 and fed back to the venturi input of the venturi 158, in accordance with some embodiments of the invention.

As also depicted in FIG. 5, in accordance with some embodiments of the invention, the conduit 70 from the hydration pump 80 may be coupled to the anode water injection tube inlet 51 and also connected to the inlet 61 of the cathode water injection tube 60.

Additionally, in accordance with some embodiments of the invention, the fuel cell system 150 may include a heater 190 for purposes of heating the water that is provided to the anode 50 and cathode 60 injection tubes. In this regard, the heater 190 may be coupled in line with the conduit 70 for purposes of heating the incoming water flow to the injection tubes 50 and 60. The heater 190 may be activated, for example, for purposes of assisting with warming up the water flow to the stack assembly 12 during the startup of the fuel cell system 150 and may be also used during the steady state operation of the hydration subsystem 10 (see FIG. 1).

In accordance with some embodiments of the invention, the fuel cell system 150 may continuously monitor the moisture content in one or more reactant flows for purposes of determining when to start and when to stop the hydration subsystem 10. In this regard, in accordance with some embodiments of the invention, the fuel cell system 150 may include a moisture content sensor 200 that is communication with a reactant (such as in communication with the anode exhaust recirculation flow) for purposes of monitoring the moisture content of the reactant flow. When the moisture content is below a predetermined level, the hydration pump 80 may then be activated for purposes of activating the hydration subsystem 10 to inject water into the anode 50 and cathode 60 water injection tubes. Once the fuel cell system 50 has efficiently started up (as determined by time or a power efficiency measurement, for example) and/or the moisture content is above a predetermined level, the fuel cell system 150 may then deactivate the hydrate subsystem and thus, turn off the hydration pump 80. Therefore, many variations are possible and are within the scope of the appended claims.

Among its other features, in accordance with some embodiments of the invention, the fuel cell system 150 includes a controller 220 (one or more microcontrollers or microprocessors, for example) that may, for example, monitor the moisture content of one or more reactive streams and control the hydration subsystem accordingly. In this regard, the controller 220 may include input terminals 224 to sense voltages, currents, sensor values, reading (via communication line 201 from the water content sensor 200), messages from other entities, etc. Based on the signals that are received by the controller 220, the controller 220 may execute software or firmware instructions to enable the heater 190, enable the hydration pump 80, etc. In this regard, the controller 220 may include various output terminals 226 for purposes of controlling the hydration pump 80 and the heater 190 in response to measured parameters. Furthermore, the controller 220 may enable the hydration subsystem 10 (by enabling the pump 80, for example) upon startup of the fuel cell system and disable (by disabling the pump 80, for example) the hydration subsystem thereafter. Or, alternatively, as set forth above, the controller 220 may monitor the water content of the reactive streams and enable the hydration subsystem when needed. Thus, many variations are possible and are within the scope of the appended claims.

As also depicted in FIG. 5, in accordance with some embodiments of the invention, the fuel cell system 150 may include power conditioning circuitry 198 that is coupled to terminals 180 of the stack assembly 12. In particular, the terminals 180 may be coupled to the power stack 40. The power conditioning circuitry 190 conditions the power from the power stack 40 for the appropriate form for the load 200. For example, if the load 200 is an AC load, the power conditioning circuitry 190 may include a DC-to-DC regulator for purposes of converting the DC level from the power stack 40 (see also FIG. 1) to the appropriate level and may also include an inverter for purposes of converting the DC voltage to the appropriate AC voltage for the load 200. If the load, however, is a DC load, then the power conditioning circuitry 190 may include a DC-to-DC converter for purposes of regulating the stack voltage of the power stack 40 to the appropriate DC level for the load 200. Thus, many variations are possible and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
communicating a reactant stream into a reactant plenum passageway of an electrochemical cell stack; and
inside the reactant plenum passageway, injecting water into the reactant steam.

2. The method of claim 1, wherein injecting comprises orienting a stream associated with the injecting toward flow channels of flow plates of the stack.

3. The method of claim 1, wherein injecting comprises communicating the water through a tubing that extends inside the plenum passageway.

4. The method of claim 3, wherein injecting comprises communicating the water through openings of the tubing.

5. The method of claim 4, wherein injecting comprises orienting the openings toward flow channel inlets of flow plates of the stack.

6. The method of claim 1, wherein the act of communicating the reactant stream comprises communicating a fuel flow.

7. The method of claim 1, wherein the act of communicating the reactant stream comprises communicating an oxidant flow.

8. The method of claim 1, further comprising:
performing the injection during startup of the electrochemical stack and halting the injection after completion of startup.

9. The method of claim 1, further comprising:
performing the injection in response to determining the reactant stream is below a predetermined hydration level.

10. A system comprising:
an electrochemical cell stack comprising a reactant plenum passageway; and
an injector located inside the reactant plenum passageway to inject water into the reactant steam.

11. The system of claim 10, wherein the injector comprises a tubing located inside the reactant plenum passageway.

12. The system of claim 11, wherein the electrochemical stack comprises flow plates, the reactant plenum passageway is formed from openings in the flow plates and the tubing is separate from the flow plates.

13. The system of claim 11, wherein the electrochemical stack comprises a first section adapted to function as an electrochemical pump and a second section to function as a fuel cell stack to produce electrical power.

14. The system of claim 13, wherein the reactant plenum passageway comprises a passageway extending between the first and second sections.

15. The system of claim 11, wherein the tubing comprises disposed along a longitudinal axis of the tubing to inject the water.

16. The system of claim 15, wherein the openings of the tubing are oriented toward flow channel openings of the stack.

17. The system of claim 10, further comprising:
a venturi adapted to combine an exhaust flow from the stack with fuel to produce an incoming fuel flow to the plenum passageway.

18. The system of claim 10, wherein the reactant plenum passageway communicates an oxidant flow.

19. The system of claim 10, wherein the injector is part of a control subsystem adapted to inject the water in response to a startup phase of the system.

20. The system of claim 10, wherein the injector is part of a control subsystem adapted to inject the water in response to a hydration of the reactant stream being below a predetermined level.

21. The system of claim 10, further comprising:
a heater to heat the water prior to its injection into the reactant stream.
